(19) United States
(12) Patent Application Publication
(10) Pub. No.: US 2011/0119416 A1
(43) Pub. Date: May 19, 2011

(54) Storage Control Method and Related Storage Control Device for a Computer System

(76) Inventor: Zhi-Ming Sun, Hsinchu City (TW)

(21) Appl. No.: 12/761,386

(22) Filed: Apr. 15, 2010

(30) Foreign Application Priority Data
Nov. 16, 2009 (TW) 098138819

(51) Int. Cl. G06F 13/12; G06F 12/00

(52) U.S. Cl. 710/74; 711/154; 711/E12.001

(57) ABSTRACT

A storage control method for a computer system for automatically executing connection at a proper time includes a storage control device generating a command for accessing a storage device, outputting the command through a port multiplier, and the computer system transmitting a signal to the port multiplier to form a connection state with the storage control device when a connection request is received by the storage control device.

### BACKGROUND OF THE INVENTION

1. Field of the Invention

The present invention relates to a storage control method and related storage control device for a computer system, and more particularly, to a storage control method and related storage control device for automatically executing connection at a proper time.

2. Description of the Prior Art

A storage device is always an integral part of a computer system, and there are various storage devices with different functions, such as floppy disks, hard disks, CD-ROMs, flash memory, and so on. As to data transmission between the computer system and the storage device, the computer system usually utilizes a storage controller for converting an order from the computer system to a command for accessing the storage device. That is, data in the storage device needs to be processed via the computer system, and as a result, for utilization convenience, kinds of external interface devices are developed for facilitating the computer system to connect with the storage device. Therefore, the computer system can simply and quickly access the storage device via this external connection method.

In the prior art, the external connection method utilizes a port multiplier with a plurality of connecting ports for connecting a plurality of storage devices simultaneously to the port multiplier with the storage controller. According to this connection method, the storage device in any one of the plurality of connecting ports can perform data transmission with the computer system through the storage controller.

Based on the abovementioned external connection method, when the computer system is booted, the storage controller transmits a connection signal to the port multiplier, and after the port multiplier responds to the connection signal, the storage controller establishes a connection with the port multiplier. At this time, the storage controller is preset in a busy state. Please note that, when the storage controller stays in the busy state, just a few commands can be transmitted. After the storage device is ready (generally, the storage device will be ready within 10 seconds), the storage device transmits a ready packet to the storage controller. Then, the storage controller leaves the busy state according to the ready packet, and enters a ready state. That is, after the storage controller is connected to the storage device, the storage controller still needs to wait for the ready packet sent by the storage device when ready to access the storage device normally.

In the prior art, the storage controller stays in the busy state and cannot communication with the storage device when the storage device is not ready. In order to avoid this situation, the computer system can transmit a software reset command to the storage device, and thereby the storage device is forced to transmit the ready packet for ready state entrance of the storage controller. However, compatibility issues for the software reset command may occur. That is, the software reset command is not valid for all of the storage devices. For example, a storage device that received the software reset command may not transmit a ready packet for the storage controller, and thereby the storage controller cannot enter the ready state.

### SUMMARY OF THE INVENTION

Therefore, the present invention provides a storage control method and related storage control device for a computer system, for automatically executing connection at a proper time.

The present invention discloses a storage control method for a computer system for automatically executing connection at a proper time. The storage control method includes a storage control device generating a command for accessing a storage device, outputting the command through a port multiplier, and the computer system transmitting a signal to the port multiplier to form a connection state with the storage control device when a connection request is received by the storage control device.

The present invention further discloses a storage control device for a computer system for automatically executing connection at a proper time. The storage control device includes a storage controller connected to the computer system, comprising a first slot and a general purpose input/output (GPIO) pin, for transmitting a command through the first slot for accessing a storage device, and a port multiplier embedded in the first slot of the storage controller through an interface and connected to the GPIO pin through a second slot, for outputting the command, wherein the computer system transmits a signal to the port multiplier through the GPIO pin for forming a connection state between the port multiplier and the storage controller when a connection request is received by the storage controller.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a storage control device according to an embodiment of the present invention.

FIG. 2 is a flowchart diagram of a storage control process according to an embodiment of the present invention.

### DETAILED DESCRIPTION

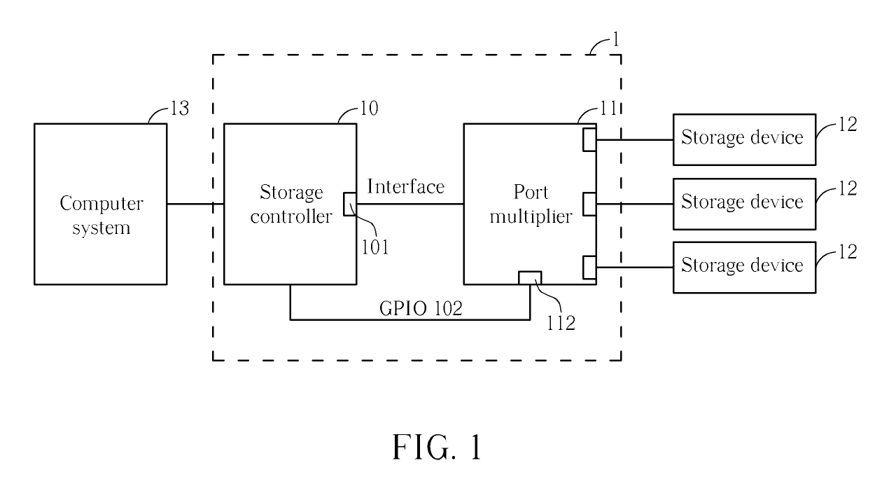

Please refer to FIG. 1, which is a schematic diagram of a storage control device 1 for a computer system 13 according to an embodiment of the present invention. Storage control device 1 can automatically execute connection at a proper time, which includes a storage controller 10 and a port multiplier 11. The storage controller 10 is connected to the computer system 13 and includes a first slot 101 and a general purpose input/output (GPIO) pin 102 for transmitting a command through the first slot 101 for accessing a storage device 12. The port multiplier 11 is embedded in the first slot 101 of the storage controller 10 through an interface 111, and is connected with the GPIO pin 102 through a second slot 112 for outputting the command from the storage controller 10. In addition, when a connection request is received by the storage controller 10, the computer system 13 transmits a signal to the port multiplier through the GPIO pin 102 for forming a connection state between the port multiplier 11 and the storage controller 10.

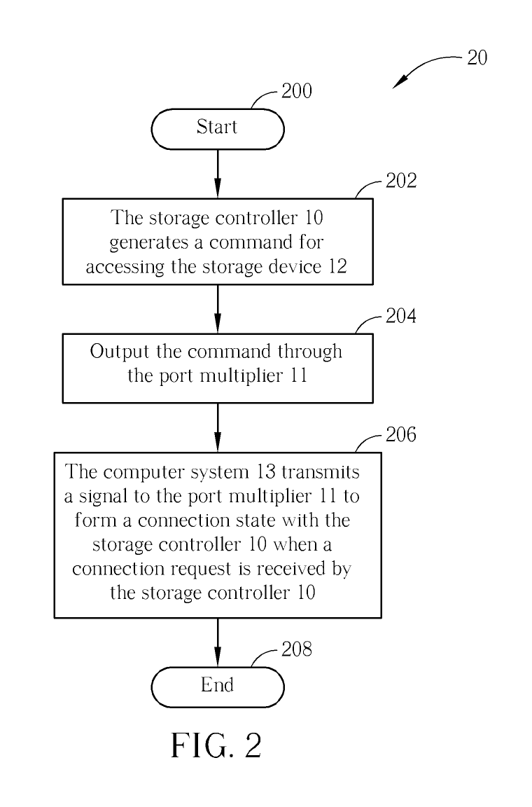

Upon an operation of the storage control device 1, please refer to FIG. 2, which can be included into a storage control process 20 for automatically executing connection at a proper time. In FIG. 2, the storage control process 20 includes the following steps:

Step 200: Start.

Step 202: The storage controller 10 generates a command for accessing the storage device 12.

Step 204: Output the command through the port multiplier 11.

Step 206: The computer system 13 transmits a signal to the port multiplier 11 to form a connection state with the storage controller 10 when a connection request is received by the storage controller 10.

Step 208: End.

Therefore, via the storage control process 20, the computer system 13 can transmit a signal to the port multiplier 11 to form a connection state with the storage controller 10 when the storage controller 10 receives the connection request, so as to perform data and command transmission.

In the present invention, automatically executing connection at a proper time indicates when the storage controller 10 is in a disconnected state with the port multiplier 11 but a user wants to access the storage device 12, the port multiplier 11 can automatically perform connection with the storage controller 10. Detailed description can be referred as following.

First, the user utilizes the computer system 13 to transmit a connection request to the storage controller 10, and the storage controller 10 then transmits a signal (such as wakeup signal) to the port multiplier 11 through GPIO pin 102 for notifying the port multiplier 11 to transmit a connection signal (such as an out-of-band signal) to the storage controller 10. After the storage controller 10 responds to the connection signal, a connection between the port multiplier 11 and the storage controller 10 is established. As an example, when the storage controller 10 is in a busy state and a new storage device 12 is connected to the port multiplier 11, the storage control 10 cannot transmit any data or command because a ready packet has not been received. In this situation, an embodiment of the present invention utilizes the GPIO pin 102 controlled by a program of the computer system 13 to transmit a signal (such as a sideband signal) to the port multiplier 11 for notifying the port multiplier 11 to transmit a ready packet to the storage control 10. Thus, the storage controller 10 can enter the ready state, and transmit data or access command to the storage device 12.

Please note that, the storage control device 1 shown in FIG. 1 is only an exemplary embodiment, and those skilled in the art can make alternations and modifications accordingly. For example, the port multiplier 11 is preferably a Serial Advanced Technology Attachment (SATA) port multiplier which receives and transmits the command from the storage controller 10 through a SATA interface. In addition, the storage controller 10 is usually a host bus adaptor, and is preferably a SATA host bus adaptor.

In the storage control device 1, when the port multiplier 11 is in the disconnected state for the storage controller 10 and the storage controller 10 receives the connection request from the computer system 13, the program of the computer system 13 can control the GPIO pin 102 to transmit a signal to the port multiplier 11 for turning the port multiplier 11 into the connection state. The present invention further utilizes the GPIO pin 102 to transmit a signal for notifying the port multiplier 11 to transmit a ready packet to the storage control 10, and thereby the storage controller 10 can leave the busy state and enter the ready state, so as to perform data and command transmission. In comparison, in the prior art, the computer system needs storage controller to transmit software reset command to the storage device, thereby causing compatibility problems and making the storage controller unable to enter the ready state.

In conclusion, in the present invention, when the port multiplier 11 is in the disconnected state for the storage controller 10, the storage controller 10 utilizes GPIO pin 102 for transmitting a signal to the port multiplier 11, and thereby the port multiplier 11 can be turned into the connection state for the storage controller 10. In addition, when the storage controller 10 is in the busy state, the present invention can utilize GPIO pin 102 to turn the storage controller into the ready state, so as to perform data transmission.

Those skilled in the art will readily observe that numerous modifications and alterations of the device and method may be made while retaining the teachings of the invention.

What is claimed is:

1. A storage control method for a computer system for automatically executing connection at a proper time comprising:
a storage control device generating a command for accessing a storage device;
outputting the command through a port multiplier; and
the computer system transmitting a signal to the port multiplier to form a connection state with the storage control device when a connection request is received by the storage control device.

2. The storage control method of claim 1, wherein the signal is a sideband signal for notifying the port multiplier to transmit a ready packet to the storage control device.

3. The storage control method of claim 1, wherein the signal is a wakeup signal for notifying the port multiplier to transmit a connection signal to the storage control device.

4. The storage control method of claim 3, wherein the connection signal is an out-of-band (OOB) signal.

5. The storage control method of claim 1, wherein the storage control device comprises a general purpose input/output (GPIO) pin controlled by a program of the computer system.

6. The storage control method of claim 2, wherein the ready packet is used for notifying the storage control device to transmit an access command to the port multiplier.

7. The storage control method of claim 1, wherein the storage control device is a Serial Advanced Technology Attachment (SATA) host bus adaptor.

8. The storage control method of claim 1, wherein the port multiplier is a Serial Advanced Technology Attachment (SATA) port multiplier.

9. The storage control method of claim 1, wherein the port multiplier is received the command by a Serial Advanced Technology Attachment (SATA) interface for transmitting the command.

10. The storage control method of claim 1, wherein the port multiplier is in a disconnected state with the storage control device.

11. A storage control device for a computer system for automatically executing connection at a proper time comprising:
a storage controller connected to the computer system, comprising a first slot and a general purpose input/output (GPIO) pin, for transmitting a command through the first slot for accessing a storage device; and
a port multiplier embedded in the first slot of the storage controller through an interface and connected to the GPIO pin through a second slot, for outputting the command;
wherein the computer system transmits a signal to the port multiplier through the GPIO pin for forming a connection state between the port multiplier and the storage controller when a connection request is received by the storage controller.

12. The storage control device of claim 11, wherein the signal is a sideband signal for notifying the port multiplier to transmit a ready packet to the storage controller.

13. The storage control device of claim 11, wherein the signal is a wakeup signal for notifying the port multiplier to transmit a connection signal to the storage controller.

14. The storage control device of claim 13, wherein the connection signal is an out-of-band (OOB) signal.

15. The storage control device of claim 11, wherein the general purpose input/output (GPIO) pin is controlled by a program of the computer system.

16. The storage control device of claim 12, wherein the ready packet is used for notifying the storage controller to transmit an access command to the port multiplier.

17. The storage control device of claim 11, wherein the storage controller is a Serial Advanced Technology Attachment (SATA) host bus adaptor.

18. The storage control device of claim 11, wherein the port multiplier is a Serial Advanced Technology Attachment (SATA) port multiplier.

19. The storage control device of claim 11, wherein the interface is a Serial Advanced Technology Attachment (SATA) interface.

20. The storage control device of claim 11, wherein the port multiplier is in a disconnected state with the storage controller.
